(19) United States
(12) Patent Application Publication
(10) Pub. No.: US 2013/0265937 A1
(43) Pub. Date: Oct. 10, 2013

(54) MACHINE TYPE COMMUNICATION (MTC) VIA NON-ACCESS STRATUM LAYER

(71) Applicants: Puneet Jain, Hillsboro, OR (US); Ana Lucia Pinheiro, Breinigsville, PA (US)

(72) Inventors: Puneet Jain, Hillsboro, OR (US); Ana Lucia Pinheiro, Breinigsville, PA (US)

(21) Appl. No.: 13/631,028

(22) Filed: Sep. 28, 2012

Related U.S. Application Data
(60) Provisional application No. 61/621,930, filed on Apr. 9, 2012.

(51) Int. Cl. H04W 88/02

(52) U.S. Cl. 370/328

(57) ABSTRACT

Technology for providing a machine type communication (MTC) service via a non-access stratum (NAS) layer is disclosed. In an example, a wireless device can include a NAS layer module, an application processor, and a MTC dispatcher. The NAS layer module can provide mobility management (MM) and session management (SM) for different radio access technology (RAT) signaling via the NAS layer. The application processor can process a MTC application running on the wireless device. The MTC dispatcher within the NAS layer module or the application processor can be used identify a MTC type of service in a message and perform an action based on the MTC type of service.

### RELATED APPLICATIONS

This application claims the benefit of and hereby incorporates by reference U.S. Provisional Patent Application Ser. No. 61/621,930, filed Apr. 9, 2012, with an attorney docket number P44661Z.

### BACKGROUND

Wireless mobile communication technology uses various standards and protocols to transmit data between a node (e.g., a transmission station) and a wireless device (e.g., a mobile device). Some wireless devices communicate using orthogonal frequency-division multiple access (OFDMA) in a downlink (DL) transmission and single carrier frequency division multiple access (SC-FDMA) in an uplink (UL) transmission. Standards and protocols that use orthogonal frequency-division multiplexing (OFDM) for signal transmission include the third generation partnership project (3GPP) long term evolution (LTE), the Institute of Electrical and Electronics Engineers (IEEE) 802.16 standard (e.g., 802.16e, 802.16m), which is commonly known to industry groups as WiMAX (Worldwide interoperability for Microwave Access), and the IEEE 802.11 standard, which is commonly known to industry groups as WiFi.

In 3GPP radio access network (RAN) LTE systems, the node can be a combination of Evolved Universal Terrestrial Radio Access Network (E-UTRAN) Node Bs (also commonly denoted as evolved Node Bs, enhanced Node Bs, eNodeBs, or eNBs) and Radio Network Controllers (RNCs), which communicates with the wireless device, known as a user equipment (UE). The downlink (DL) transmission can be a communication from the node (e.g., eNodeB) to the wireless device (e.g., UE), and the uplink (UL) transmission can be a communication from the wireless device to the node.

A wireless device can include a human-oriented wireless device (e.g., human operated wireless device), a machine type communication (MTC) device, and/or a machine-to-machine (M2M) device. The human operated wireless device can include a computing device configured with a interface to be operated by a human operator capable of wireless digital communication such as a smart phone, a tablet computing device, a laptop computer, a multimedia device such as an iPod Touch®, or other type computing device that provides text or voice communication. A MTC or M2M device can include a sensor and/or a processor configured to automatically access and communicate wirelessly with a RAN. As used herein, MTC and M2M may be used interchangeably.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a block diagram of a third generation partnership project (3GPP) architecture in accordance with an example;

FIG. 2 illustrates a block diagram of a service capability (SC) layer and a machine type communication (MTC) dispatcher in a protocol stack in accordance with an example;

FIGS. 3A-B illustrate a block diagram of an example message sequence chart in accordance with an example;

FIG. 4 illustrates a block diagram of a machine type communication (MTC) dispatcher in a protocol stack and a service capability (SC) layer outside the protocol stack in accordance with an example;

FIG. 5 illustrates a block diagram of a machine type communication (MTC) dispatcher outside a protocol stack in accordance with an example;

FIG. 6 depicts a flow chart of a method for communicating a machine type communication (MTC) service via a non-access stratum (NAS) layer in accordance with an example;

FIG. 7 illustrates a block diagram of a node and a wireless device in accordance with an example; and

FIG. 8 illustrates a diagram of a wireless device in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

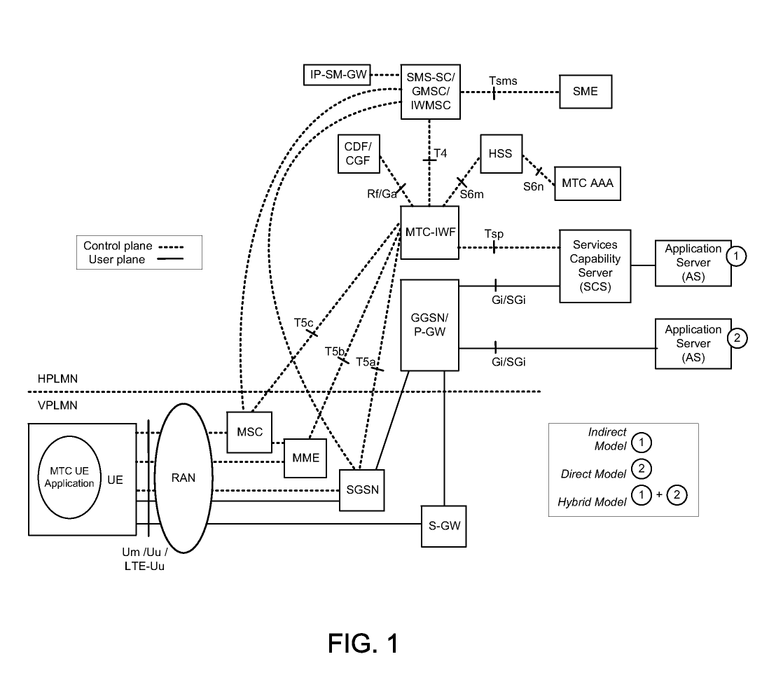

FIG. 1 illustrates a third generation partnership project (3GPP) network architecture that can support wireless devices (e.g., UEs), including wireless devices used for machine-to-machine (M2M) communications and machine type communication (MTC). The 3GPP architecture allows for a service capabilities server (SCS) to connect to the 3GPP network either via a (S)Gi interface or via a Tsp interface. The Gi interface can be an internet protocol (IP) based interface between the gateway general packet radio service (GPRS) support node (GGSN) and a public data network (PDN) either directly to the Internet or through a wireless application protocol (WAP) gateway. The SCS can act as a secure gateway between an internet protocol (IP) multimedia subsystem (IMS) network and an application which runs upon an application server (AS) in an open services architecture (OSA). The SCS can be either inside or outside an operator domain. The operator domain can include entities and functions that can be managed and controlled by a network operator. The application server (AS) can connect to the IMS network and/or core network (e.g., evolved packet core (EPC)) using an indirect model via the SCS, a direct model, or a hybrid model via the SCS and/or through direct signaling.

The (S)Gi interface (e.g., SGi or Gi interface) can be an interface that allows for internet protocol (IP) packets to be exchanged between a 3GPP domain and a non-3GPP domain. The (S)Gi interface can be used when a radio access bearer is established between the wireless device (e.g., UE) and an edge of the 3GPP core network (e.g., gateway general packet radio service (GPRS) support node (GGSN) or packet data network (PDN) gateway (P-GW)). The gateway GPRS support node (GGSN) can be a network node that acts as a gateway between a GPRS wireless data network and other networks. The GGSN can store subscriber data received from a home location register (HLR) and/or a serving GPRS support node (SGSN), as well as an address of the SGSN where each wireless device is registered. The PDN gateway (P-GW or PGW) can provide connectivity from the wireless device to external packet data networks by being the point of exit and entry of traffic for the wireless device. A wireless device can have simultaneous connectivity with more than one P-GW for accessing multiple PDNs. The P-GW can perform policy enforcement, packet filtering for each user, charging support, lawful interception and packet screening. The P-GW can act as the anchor for mobility between 3GPP and non-3GPP technologies such as WiMAX and 3GPP2.

The Tsp interface can allow for communication between the SCS and the wireless device (e.g., UE) that can be used for M2M communication. The machine type communications-interworking function (MTC-IWF) can be an entity responsible for receiving a device trigger request from the SCS and determining a route for the request to reach the wireless device, and then triggering the device. The MTC-IWF can be in communication with a serving general packet radio service (GPRS) support node (SGSN) using a T5a interface, a mobility management entity (MME) using a T5b interface, a mobile switching center (MSC) using a T5c interface, a home subscriber server (HSS) using an S6m interface, a charging data function/charging gateway function (CDF/CGF) using a Rf/Ga interface, and short message service (SMS) service center (SMS-SC)/gateway mobile switching center (GMSC)/interworking mobile services switching center (IWMSC) (SMS-SC/GMSC/IWMSC) using a T4 interface. The HSS can be in communication with a machine type communications authentication, authorization, and accounting (MTC AAA) server using an S6n interface.

The serving GPRS support node (SGSN) can be responsible for the delivery of data packets from and to the wireless device within a geographical service area. The tasks of the SGSN can include packet routing and transfer, mobility management (e.g., attach/detach and location management), logical link management, and authentication and charging functions. The location register of the SGSN can store location information (e.g., current cell, current visitor location register (VLR)) and user profiles (e.g., international mobile subscriber identity (IMSI), address(es) used in the packet data network) of GPRS users registered with this SGSN.

The mobility management entity (MME) can be a control node which can process the signaling between the wireless device and the core network (CN) and provide visitor location register (VLR) functionality for an evolved packet system (EPS). The MME can support functions related to bearer and connection management. In an example, the MME can be control-node for a LTE access-network responsible for idle mode UE tracking and paging procedure including retransmissions. The MME can be involved in a bearer activation/deactivation process and can also be responsible for choosing the serving gateway (S-GW or SGW) for a UE at an initial attach and at time of an intra-LTE handover involving CN node relocation. The MME can be responsible for authenticating the user (by interacting with the HSS). In an example, the non access stratum (NAS) signaling can terminate at the MME and the MME can also be responsible for generation and allocation of temporary identities to UEs. The MME can check the authorization of the UE to camp on the service provider's public land mobile network (PLMN) and can enforce UE roaming restrictions. The MME can be a termination point in the network for ciphering/integrity protection for NAS signaling and can handle the security key management. Lawful interception of signaling can be supported by the MME. The MME can provide the control plane function for mobility between LTE and 2G/3G access networks with a S3 interface terminating at the MME from the SGSN (not shown). The MME can also terminate the S6a interface towards the home HSS for roaming UEs.

A public land mobile network (PLMN) can include a network established and operated by a regulatory body, an administration, or a recognized private operating agency (RPOA) for a specific purpose of providing land mobile communication services to the public. A relationship can exist between each subscriber and the subscriber's home PLMN (HPLMN). If communications are handled over another PLMN, the other PLMN can be referred to as a visited PLMN (VPLMN). A PLMN may provide service in one, or a combination, of frequency bands. A PLMN can be defined by borders of a country. More than one PLMN can exist in a country. The PLMN area can be the geographical area in which a PLMN provides communication services.

The mobile switching center (MSC) can provide an interface between a radio system and a fixed network. The MSC can perform functions in order to handle circuit switched (CS) services to and from the wireless devices.

The serving gateway (S-GW or SGW) can route and forward user data packets, while acting as a mobility anchor for a user plane during inter-eNodeB handovers and as an anchor for mobility between LTE and other 3GPP technologies (terminating S4 interface and relaying the traffic between 2G/3G systems and PGW). For idle state UEs, the S-GW can terminate the downlink data path and triggers paging when downlink data arrives for the UE. The S-GW can manage and store UE contexts, parameters of the IP bearer service, and network internal routing information. The S-GW can perform replication of the user traffic in case of lawful interception.

The S-GW, SGSN, MME, and/or MSC can communicate with a wireless device (e.g., UE) via a radio access network (RAN) using the Um, Uu, and/or LTE-Uu interface. The wireless device can run a MTC UE application.

The home subscriber server (HSS) can include a central database that contains user-related and subscription-related information. The functions of the HSS can include functionalities such as mobility management, call and session establishment support, user authentication and access authorization. In an example, the HSS can be based on home location register (HLR) and authentication center (AuC).

The machine type communications authentication, authorization, and accounting (MTC AAA) server or function can provide security protocols for MTC devices. The MTC AAA security protocols enables control over which MTC devices are allowed access to which resources (e.g., applications and services), and recording of how much of the resources MTC devices have used. The MTC AAA server or function can include processes involve establishing a MTC device's identity, configuring authorizations to access particular types of services and applications, and monitoring traffic volumes for each MTC device.

The charging data function and/or charging gateway function (CDF/CGF) can collect data and send collected data to a billing system. The charging data function (CDF) can create charging data records (CDR), and record charging duration and timing and other session details. The charging gateway function (CGF) can centralize the collection of CDRs and performs some basic preprocessing and transformation to provide consistent interface to a billing domain (BD).

The short message service (SMS) service center (SC) (SMS-SC) or short message service center (SCMS) can be a network element in the mobile telephone network which delivers SMS messages (e.g., text message). The SCMS can be responsible for the relaying and store-and-forwarding of a short message between a short messaging entity (SME) and the wireless device. The gateway mobile switching center (GMSC) can handle registration, authentication, location updating, handovers, and call routing functions for a wireless device. The GMSC can have the standard functionality of a mobile switching center (MSC) and can provide interconnectivity between other licensed operators by functioning as a gateway between two networks. The SMS gateway MSC (SMS-GMSC) can be an MSC capable of receiving a short message from an SMSC, interrogating a home location register (HLR) for routing information, and delivering the short message to the “visited” MSC of the recipient wireless device. The SMS interworking MSC (SMS-IWMSC or IWMSC) can be an MSC capable of receiving a short message from the mobile network and submitting the short message to an appropriate SMSC. The SMS-GMSC/SMS-IWMSC can be integrated with the SMSC. The SMS-SC, SMS-GMSC, and/or SMS-IWMSC can provide control plane functionality to the SGSN and MSC. The SMS-SC/GMSC/IWMSC can provide connectivity for an internet protocol short message gateway (IP-SM-GW) and a short message entity (SME) (using a Tsms interface) to the core network via the MTC-IWF. The short messaging entity (SME) can be an entity which may receive or send short messages. In an example, the SME can be located in the fixed network, a mobile station, or another service center. The IP-SM-GW can provide protocol interoperability between the SMS and the IMS messaging services.

In computer networking and/or wireless communication, different functions can be provided by different layers in a protocol stack. The protocol stack can be an implementation of a computer networking protocol suite. The protocol stack (or protocol suite) can include the definition and implementation of the protocols. Each layer or protocol in the protocol stack can provide a specified function. The modularization of the layers and protocols can make design and evaluation of the computer networking and/or wireless communication easier. In an example, each protocol module or layer module in a stack of protocols may communicate with at least two other modules (e.g., a higher layer and a lower layer). The lowest protocol or layer can provide low-level, physical interaction with the hardware.

Each higher layer may add more features. The upper or topmost layers can include user applications.

In the LTE system, communication layers can include a physical (PHY) (i.e., layer 1 (L1)), a data link (i.e., layer 2 (L2)), a network (i.e., layer 3 (L3)), and an application layer. In an example, layer 2 (L2) can include media access control (MAC), radio link control (RLC), or packet data convergence protocol (PDCP) layers, and layer 3 (L3) can include a radio resource control (RRC) layer. In an example, the RRC protocol can manage control plane signaling between a wireless device (e.g., a user equipment (UE)) and a radio access network (RAN) via the node (e.g., an eNB).

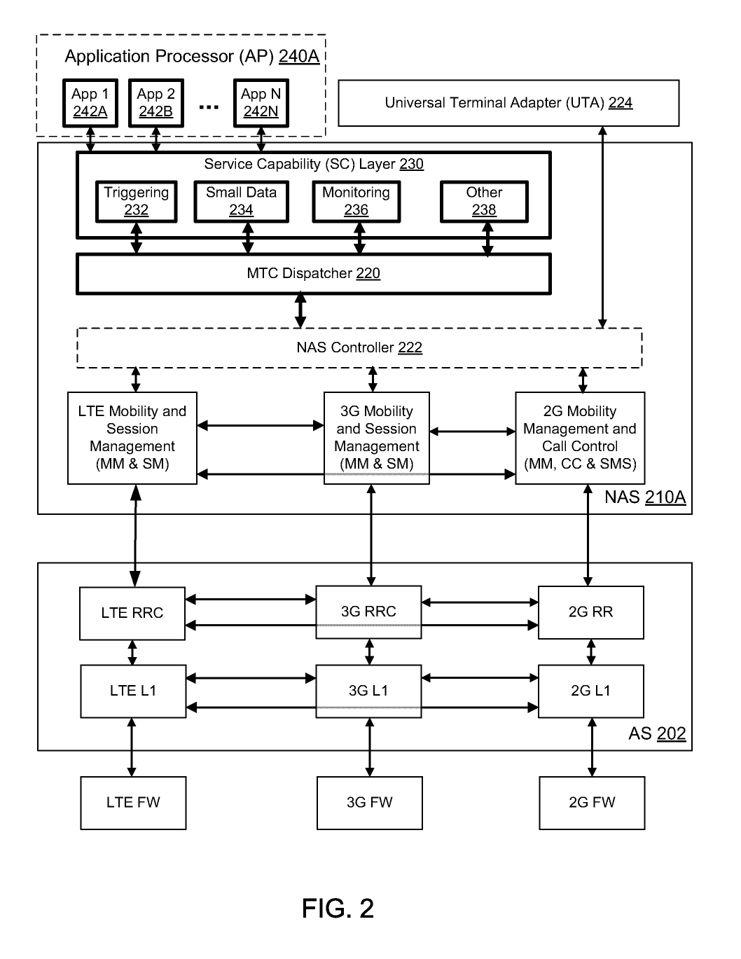

FIG. 2 illustrates a wireless device (e.g., MTC device) configured with layers in a protocol stack including specific radio access technology (RAT) firmware (FW), an access stratum (AS) 202, a non-access stratum (NAS) 210A, and an application 242A-N. The RAT firmware can interface and communicate with the AS and NAS layers. The access stratum (AS) can include protocols specific to a particular radio access technology (RAT), such as long term evolution (LTE) and third generation (3G) and second generation (2G) digital wireless technology. 2G wireless technology can include cellular telecom protocols using the global system for mobile communications (GSM) standard. GSM (originally groupe spécial mobile) is a standard set developed by the European Telecommunications Standards Institute (ETSI) to describe protocols for second generation (2G) digital cellular networks used by wireless devices (e.g., mobile phones). 3G wireless technology can include protocols that comply with the international mobile telecommunications-2000 (IMT-2000) specifications by the international telecommunication union, such as universal mobile telecommunications system (UMTS), code division multiple access 2000 (CDMA2000), and Worldwide interoperability for Microwave Access (WiMAX). UTMS is a 3GPP radio access technology for networks using wideband-code division multiple access (W-CDMA). CDMA2000 uses code division multiple access (CDMA) channel access to send voice, data, and signaling data between wireless devices (e.g., mobile phones) and cell sites. 3G wireless technology can provide applications in wireless voice telephony, mobile Internet access, fixed wireless Internet access, video calls and mobile television (TV).

The non-access stratum (NAS) can comprise protocols which can operate between the wireless device (e.g., UE) and the core network (CN). NAS can be a functional layer in the protocol stack for communication between the core network and wireless device, which supports signaling and traffic between the core network and wireless device. The NAS protocols may not be specific to a particular radio access technology (RAT). In an evolved packet system (EPS), the NAS protocols can include mainly protocols for mobility management and session management between the wireless device and the mobility management entity (MME). In an example, the AS layer and/or NAS layer processing and/or signaling can be provided by a modem module (or device). The application layer processing can be provided by an application processor 240A. The NAS layer module 210A-C (FIGS. 2 and 4-5) can communicate with a universal terminal adapter (UTA).

The wireless device can communicate with the SCS and application server (AS) using non access stratum (NAS) based communication. Various mechanisms within the wireless device (e.g., UE) can be used to allow the network to communicate with the wireless device using NAS signaling messages, which messages can allow for M2M or MTC communication. The NAS communication can allow various services, such as triggering, small data transmission, monitoring events configuration, or reporting. Triggering can allow a wireless device to communicate automatically with the network based on a specified condition. Monitoring can allow a wireless device to automatically monitor and report a specified condition to the network. FIGS. 2 and 4-5 illustrate a general framework for NAS based triggering implementations that can be implemented on the wireless device. The communication mechanism illustrated herein can be used to map a European Telecommunications Standards Institute (ETSI) technical committee (TC) machine to machine (M2M) architecture with a 3GPP MTC architecture. The wireless device can be configured as a MTC device or a human-oriented wireless device.

In an example, the network can use a “generic message” for MTC device triggering. The network can use a “Downlink Generic NAS Transport” message, and add a generic message container type information element for various container types, such as “MTC device triggering,” as illustrated below and in Table 1, or a MTC specific downlink generic NAS transport message can be defined for a MTC message. Communication with MTC devices can use a MTC container type. The Downlink Generic NAS Transport can include a usage, message definition, direction, information element indicator (IEI), information elements (IE), and type and/or reference. The message definition can indicate that the message is sent by the network to the UE in order to carry an application message in an encapsulated format. The direction can be from the network to the wireless device (e.g., UE)

Table 1 illustrates some Downlink Generic NAS Transport elements

TABLE 1

| IEI | Information Element | Type/Reference |
|---|---|---|
| | Protocol discriminator | Protocol discriminator |
| | Security header type | Security header type |
| | Downlink generic NAS transport | Message type |
| | message identity | |
| | Generic message container type | Generic message container |
| | | type |
| | Generic message service type | Generic message service type |
| | Generic message container | Generic message container |
| 65 | Additional information | Additional information |

A generic message container type information element can be used to specify a type of message contained in the generic message container IE. For example, Table 2 illustrates a generic message container type information element which includes bit encoding for “MTC Device Communication”. A generic message service type information element can be used to specify a type of message contained in the generic message service IE (not shown).

TABLE 2

| Bits | |
|---|---|
| 8 7 6 5 4 3 2 1 | |
| 0 0 0 0 0 0 0 0 | Reserved |
| 0 0 0 0 0 0 0 1 | LTE Positioning Protocol (LPP) |
| | message container (see |
| | 3GPP TS 36.355 [22A]) |
| 0 0 0 0 0 0 1 0 | Location services message |
| | container (see |
| | 3GPP TS 24.171 [13C]) |
| 0 0 0 0 0 0 1 1 | MTC Device Communication |
| 0 0 0 0 0 1 0 0 | Unused |
| To | |
| 0 1 1 1 1 1 1 1 | |
| 1 0 0 0 0 0 0 0 | |
| To | Reserved |
| 1 1 1 1 1 1 1 1 | |

When the wireless device receives a message with a generic message container type, the wireless device can decode the message for an MTC application, when the MTC device communication bit pattern (e.g., 00000011) is set. The “generic message container” can then be forwarded to a given application running on the wireless device or a specified action can be performed based on the contents of the generic message container.

In another configuration, a generic message container type information element can be used to specify a type of service contained in the generic message container IE. For example, Table 3 illustrates a generic message container type information element which includes bit encoding for a “MTC Small Data Service”, “MTC Monitoring Service”, or “Triggering Service”. Other services may also be bit encoded.

TABLE 3

| Bits | |
|---|---|
| 8 7 6 5 4 3 2 1 | |
| 0 0 0 0 0 0 0 0 | Reserved |
| 0 0 0 0 0 0 0 1 | LTE Positioning Protocol (LPP) |
| | message container (see |
| | 3GPP TS 36.355 [22A]) |
| 0 0 0 0 0 0 1 0 | Location services message |
| | container (see |
| | 3GPP TS 24.171 [13C]) |
| 0 0 0 0 0 0 1 1 | MTC Small Data Service |
| 0 0 0 0 0 1 0 0 | MTC Monitoring Service |
| 0 0 0 0 0 1 0 1 | Triggering Service |
| 0 0 0 0 0 1 1 0 | Unused |
| To | |
| 0 1 1 1 1 1 1 1 | |
| 1 0 0 0 0 0 0 0 | |
| To | Reserved |
| 1 1 1 1 1 1 1 1 | |

When the wireless device receives a message with a generic message container type, the wireless device can decode the message for an MTC small data service, when the MTC Small Data Service bit pattern (e.g., 00000011) is set; the wireless device can decode the message for an MTC monitoring service, when the MTC Monitoring Service bit pattern (e.g., 00000100) is set; or the wireless device can decode the message for a triggering service, when the Triggering Service bit pattern (e.g., 00000101) is set. The “generic message container” can then be forwarded to a service capability (SC) layer module or a given application running on the wireless device, or a specified action can be performed based on the contents of the generic message container at the SC layer module or an MTC dispatcher.

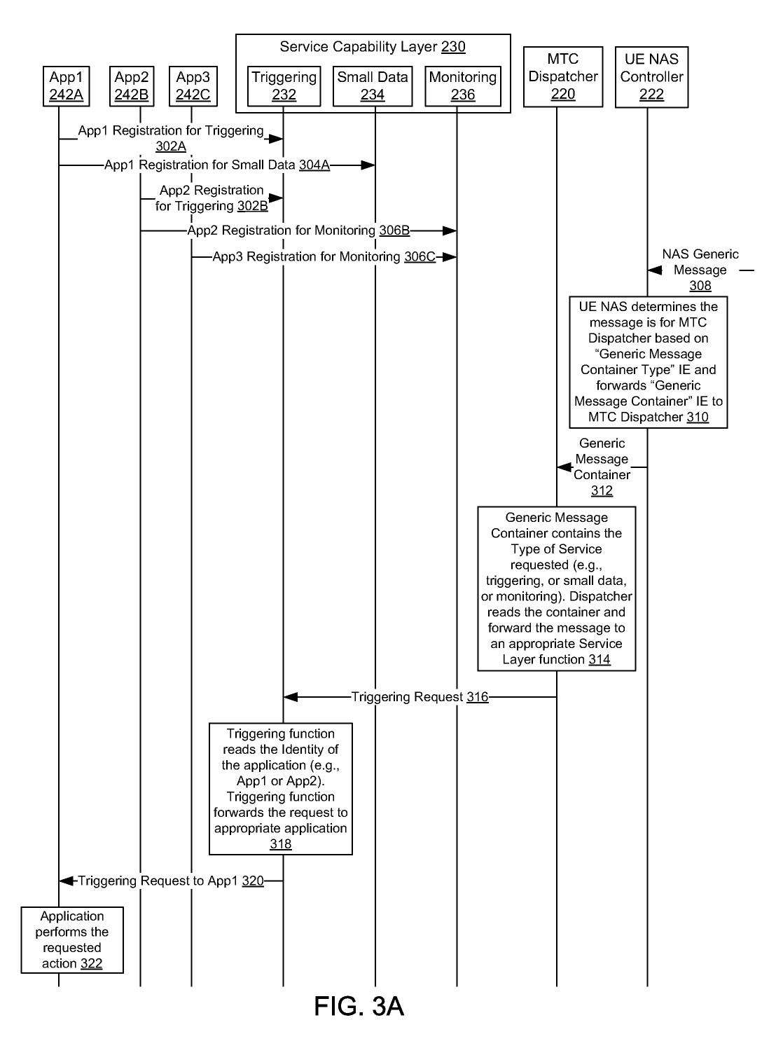

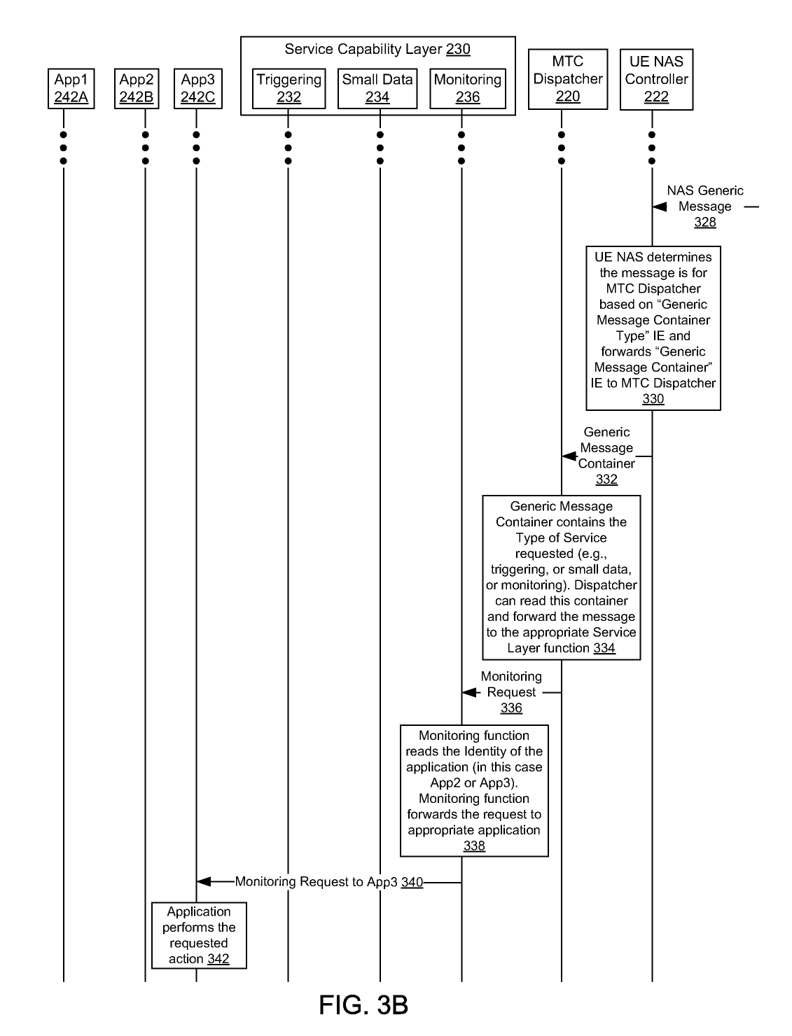

FIG. 2 illustrates a wireless device (e.g., MTC device) that can implement a service capability (SC) layer 230, which can provide different services, such as triggering 232, small data 234, monitoring 236, and other services 238, to various MTC applications 242A-N. FIGS. 3A-B illustrates a message sequence chart of an example of signaling exchange between the network and a wireless device (e.g., UE) configured for MTC and how different message containers reach different applications. In order to use a service, an application can register with the SC layer and, as part of registration, inform the SC layer which service the application wants to use. For example, App1 242A may want to use a triggering service, so App1 may register 302A with a triggering module 232 under the SC layer. App1 may want to use a small data service, so App1 may also register 304A with a small data module 234. App2 242B may also want to use the triggering service, so App 2 may register 302B with the triggering module. App2 may want to use a monitoring service, so App 2 may register 306B with a monitoring module 236. App3 may also want to use the monitoring service, so App 3 may register 306C with the monitoring module.

Based on a modification to a downlink generic NAS transport message (by adding an MTC indication) or a MTC NAS generic message (e.g., MTC specific downlink generic NAS transport message) that can be identified as a MTC-related message, the wireless device can receive a message 308 or 328 and identify the message for an MTC application 310 or 330. The wireless device can forward at least a portion of the message to the proper application (within the wireless device) or provide an action based on the MTC service specified in the message.

In an example, the wireless device can receive the generic NAS message with the generic container from the network via the SGSN or in another format (such as short message service (SMS)) from the MSC, SGSN, MME, and/or S-GW.

In an example, the wireless device can include added functionality in the NAS layer to recognize that a message is MTC. The MTC message recognition function can be provided by a NAS layer of each RAT (e.g., 2G, 3G or LTE), or a NAS controller 222 can be used that coordinates the different RATs. In either case, the message can be identified by the NAS layer to be for an MTC application. The coordination of the NAS functionality among RATs can be done directly between the separate NAS layers of each RAT, or optionally a “NAS controller” can be responsible for the coordination. The term “NAS controller” is used hereafter to describe the NAS coordination function to provide clarity of the illustrations, but the reference to the NAS controller hereafter is not intended to limit any implementation.

For example, the NAS controller 222 can read the NAS generic message and identify that the message is for MTC device communication. The NAS controller can then forward the message contents to a MTC dispatcher 220. In another example, the NAS controller on the wireless device can make a determination of the MTC type of service based on the generic message container type IE 310 or 330, and forward a generic message container to a MTC dispatcher.

FIG. 2 illustrates the MTC dispatcher 220 as a functional block within the NAS layer or the NAS layer module 210A, where the MTC dispatcher can read the message contents and identify a “type of service” requested. A generic message type can include the type of service requested. In another example, the MTC dispatcher can read the container can forward the message to an appropriate service layer function 314 or 334. The type of service can be, for example, a request for MTC triggering 316, a small data transmission, a MTC monitoring event request 336, or some other type of service that could be defined for specific MTC applications. Based on the type of service, the MTC dispatcher can then forward the message to the appropriate module (e.g., triggering 232, small data 234, or monitoring 236) in the service capability (SC) layer module 230. The different modules (e.g., triggering, small data, monitoring, or other MTC service) can then forward the request to the application based on an application identity (e.g., App1 242A, App2 242B, App3 242C . . . , AppN). The application identity can include an application name, application number, or other application identifier. For example, the triggering module (or triggering function) can read the identity of the application (e.g., App1 or App2), and the triggering module can forward the request to the appropriate application 318, as illustrated in FIGS. 3A-B. As shown, the triggering request is sent to App1 320. App1 can perform the requested action 322. In another example, the monitoring module (or monitoring function) can read the identity of the application (e.g., App2 or App3), and the monitoring module can forward the request to the appropriate application 338. As shown, the monitoring request is sent to App3 340. App3 can perform the requested action 342.

In another example (not shown), the SC layer itself can perform a decision without sending a request to the application. For example, if the triggering module receives a request then triggering module itself can be responsible for triggering the NAS layer to establish a connection. The SC layer can make decisions by itself without having to contact the application, as long as the application has registered for the specific service, such as triggering.

As illustrated again in FIGS. 3A-B, App1 242A registers with SC layer 230 for triggering 302A and small data functionality 304A, App2 242B registers with SC layer for triggering 302B and monitoring functionality 306B, and App3 242C registers with SC layer for monitoring functionality 306C. The different modules can then have the information of the registered applications.

The UE NAS (or UE NAS controller 222 shown in FIGS. 2-5) can receive a NAS generic message 308 or 328. The NAS controller can identify that the message is for an MTC application 310 or 330 using the MTC device communication IE and the NAS controller can send a message container 312 or 332 to the MTC dispatcher 220. The MTC dispatcher can be responsible for determining which module (or function) of the SC layer can receive the message. For triggering request 316, the MTC dispatcher sends the request to the triggering module 232. For small data, the MTC dispatcher sends the data to the small data module 234. For monitoring request 336, the MTC dispatcher sends the request to the triggering module 236. The module (e.g., triggering, small data, monitoring, or other MTC service) in the SC layer then reads the application identity and forwards the message/data to a given application and/or performs a specified action. The configuration shown in FIG. 2 can have an interface between the modules (or functions) of the SC layer in the modem module and the applications in the application processor.

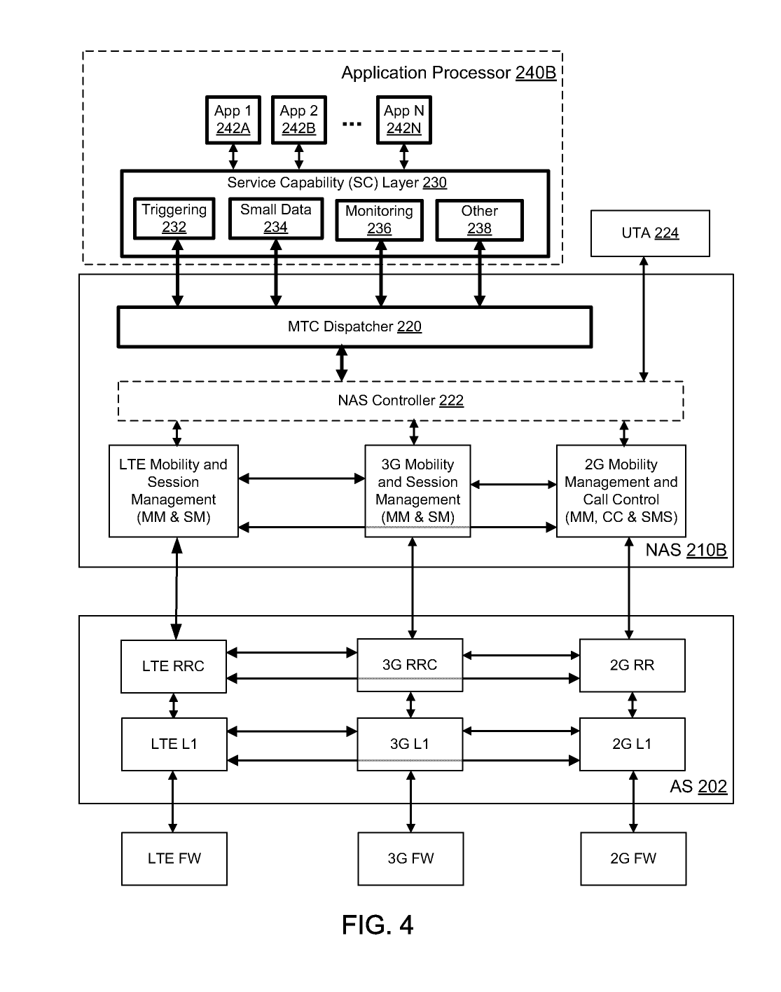

FIG. 4 illustrates another configuration where the SC layer module 230 can be located outside the protocol stack (e.g., in the application processor 240B). The MTC dispatcher can be part of the NAS layer module 2108. The MTC dispatcher can be a functional block in the NAS layer module configured to read the message contents and identify the “type of service” requested from the contents of the generic message container. The configuration shown in FIG. 4 can have an interface between the MTC dispatcher in the modem module and the modules (or functions) of the SC layer in the application processor.

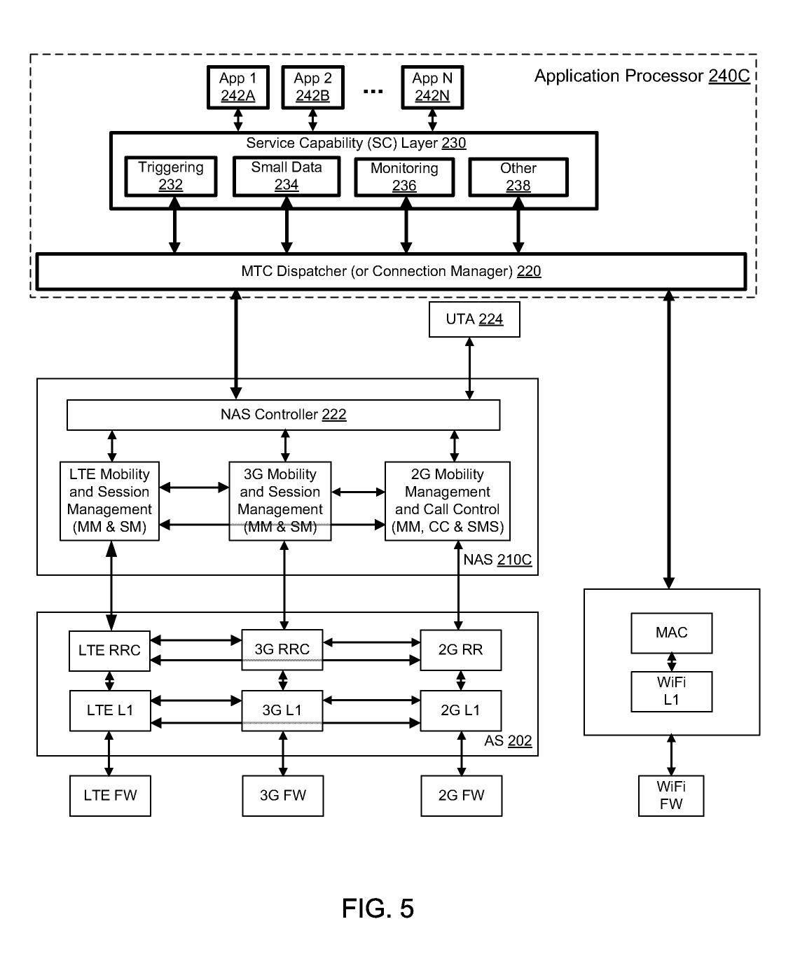

FIG. 5 illustrates another configuration where the MTC dispatcher 220 and the SC layer module 230 can be located outside the protocol stack (e.g., in the application processor 240C), where the MTC dispatcher and the SC layer module may not be included in the NAS layer module 210C of a modem module. The configuration illustrated in FIG. 5 allows for the MTC dispatcher to have added functionality to select a between various radio access technologies (RATS) to communicate back to the network when other RATs are available, such as WiFi or other wireless local area networks (WLANs). For example, the MTC dispatcher can interface and communicate with the WiFi firmware (FW) via the media access control (MAC) layer and/or layer 1 (L1 or physical (PHY)) layer of the WiFi protocol. FIG. 5 can have an interface between the NAS controller in the modem module and the MTC dispatcher in the application processor.

In an example, the configuration of FIG. 2 can integrate the NAS controller 222, the MTC dispatcher 220, and the SC layer module 230 for NAS layer processing within a single chip set used in a modem module of a wireless device, which can have faster processing speeds and optimized protocols relative to other configurations. In an example, the configuration of FIG. 5 can provide greater versatility in design with various and/or existing NAS layer modules (in the modem modules) relative to other configurations since the MTC dispatcher 220 and the SC layer module 230 functionality can be provided by the application processor. In an example, the configuration of FIG. 4 can provide an intermediate design choice between the configurations of FIGS. 2 and 5.

FIGS. 2 and 4-5 illustrate a wireless device configured for providing a machine type communication (MTC) service via a non-access stratum (NAS) layer. The wireless device can include a NAS layer module 210A-C, an application processor 240A-C, and an MTC dispatcher 220. The NAS layer module can be configured to provide mobility management (MM) and session management (SM) for different radio access technology (RAT) signaling via the NAS layer. The application processor can be configured to process an MTC application running on the wireless device. The MTC dispatcher operating within the NAS layer module or the application processor can be configured to identify an MTC type of service in a message and perform an action based on the MTC type of service. In an example, the action of MTC dispatcher can include sending a request to the MTC application based on an MTC type of service specified in the message.

In another configuration, the wireless device can include a service capability (SC) layer module 230, which can include a plurality of MTC service modules (e.g., triggering 232, small data 234, monitoring 236, and other 238). In an example, the MTC dispatcher can forward at least a portion of the message to at least one MTC service module based on the MTC type of service. An MTC service module of the SC layer module can include a triggering module for processing a request for MTC triggering, a small data module for processing a small data transmission, or a monitoring module for processing an MTC monitoring event request. The MTC service module can send a specified request to the MTC application identified in the message.

In a configuration, the MTC dispatcher 220 and the SC layer module 230 can operate within the NAS layer module 210A, as illustrated in FIG. 2. In another configuration, the MTC dispatcher can operate within the NAS layer module 210B and the SC layer module can operate within the application processor 240B, as illustrated in FIG. 4. In still another configuration, the MTC dispatcher and the SC layer module can operate within the application processor 240C, as illustrated in FIG. 5.

In another configuration, the wireless device can include a NAS controller 222, a universal terminal adapter (UTA) 224, an access stratum (AS) layer module 220, RAT specific firmware (e.g., LTE FW, 3G FW, and 2G FW), and/or a transceiver module. The NAS controller can operate within the NAS layer module and be configured to coordinate different RAT signaling via the NAS layer. The UTA can be in communication with the NAS layer module. The access stratum (AS) layer module can be in communication with the NAS layer module and be configured to provide radio resource control (RRC) and physical (PHY) layer processing and signaling. The RAT specific firmware can be in communication with AS layer module and provide wireless communication using a specified RAT. The transceiver module can be configured to communicate with a node (e.g., eNB). In an example, the node can include a base station (BS), a Node B (NB), an evolved Node B (eNB), a baseband unit (BBU), a remote radio head (RRH), a remote radio equipment (RRE), or a remote radio unit (RRU). The different RAT signaling can operate based on various wireless technologies, such as second generation (2G) digital wireless technology, third generation (3G) digital wireless technology, a third generation partnership project (3GPP) long term evolution (LTE) standard, an Institute of Electrical and Electronics Engineers (IEEE) 802.16 standard or a Worldwide interoperability for Microwave Access (WiMAX) standard, an Universal Mobile Telecommunications System (UMTS) standard, a Global System for Mobile Communications (GSM) standard, a code division multiple access 2000 (CDMA2000) standard.

In a configuration, the message can be included in a downlink generic NAS transport message with a generic message container type of an MTC device communication indication. In another configuration, the message can be included in a MTC specific downlink generic NAS transport message for MTC device communication.

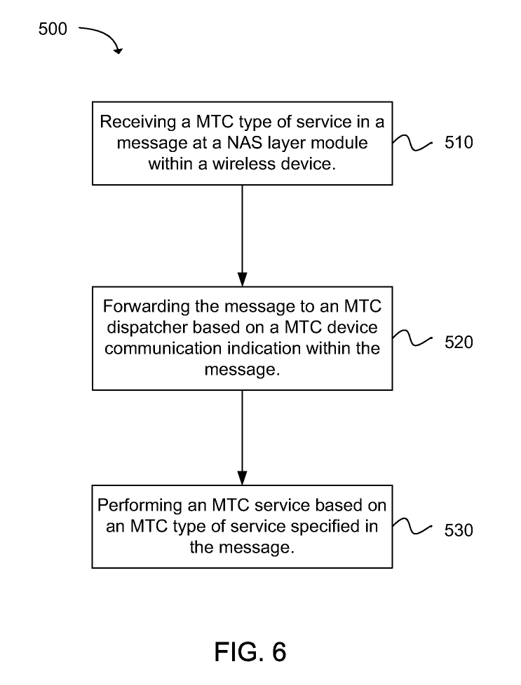

Another example provides a method 500 for communicating a machine type communication (MTC) service via a non-access stratum (NAS) layer, as shown in the flow chart in FIG. 6. The method may be executed as instructions on a machine, where the instructions are included on at least one computer readable medium or one non-transitory machine readable storage medium. The method includes the operation of receiving a MTC type of service in a message at a NAS layer module within a wireless device, as in block 610. The operation of forwarding the message to an MTC dispatcher based on a MTC device communication indication within the message follows, as in block 620. The next operation of the method can be performing an MTC service based on an MTC type of service specified in the message, as in block 630.

In an example, the operation of performing the MTC service can further include: forwarding at least a portion of the message to a service capability (SC) layer module, where the SC layer module includes a MTC service module; sending, from the MTC service module, a request to the application based on an identity of the application in the message; and performing the MTC service by the application. In example, the MTC service module can perform the functions of: triggering a request via a triggering module, processing a small data transmission via a small data module, or monitoring an event request via a monitoring module.

In a configuration, the method can further include operating the MTC dispatcher and the SC layer module within a protocol stack. In another configuration, the method can further include operating the MTC dispatcher within a protocol stack; and operating the SC layer module outside the protocol stack. In still another configuration, the method can further include operating the MTC dispatcher and the SC layer module outside a protocol stack.

In an example, the operation of receiving the MTC type of service in the message at the NAS layer module can further include receiving the message at a NAS controller via a specified radio access technology (RAT) signaling, and sending the message from the NAS controller to the MTC dispatcher. In an example, the message can be included in a downlink generic NAS transport message with a generic message container type including a MTC device communication indication, or the message can be included in a MTC specific downlink generic NAS transport message for MTC device communication.

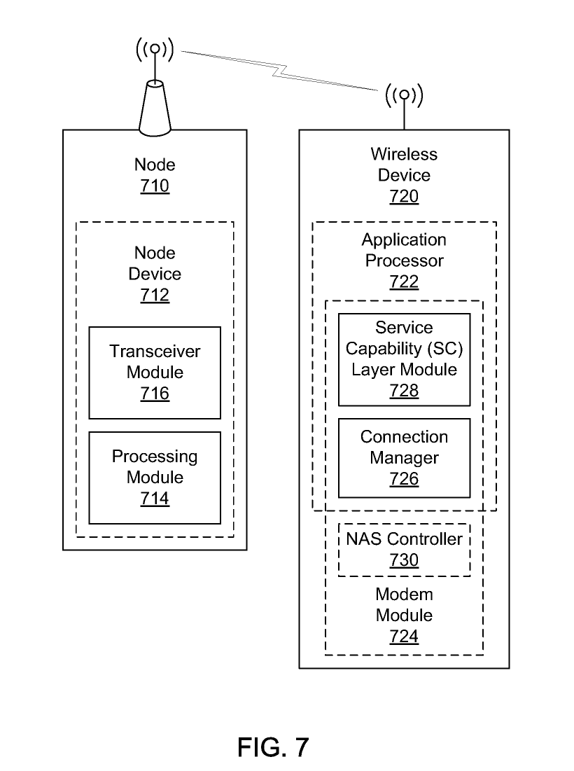

FIG. 7 illustrates an example node 710 and an example wireless device 720. The node can include a node device 712. The node device or the node can be configured to communicate with the wireless device and the core network (illustrated in FIG. 1). The node device can be configured for providing machine type communication (MTC) services via a non-access stratum (NAS) layer. The node device can include a processing module 714 and a transceiver module 716. The processing module can be configured to generate a downlink generic NAS transport message with a generic message container type including a MTC device communication indication, or generate a MTC specific downlink generic NAS transport message for MTC device communication. The transceiver module can be configured to transmit the downlink generic NAS transport message or the MTC specific downlink generic NAS transport message to a wireless device. The node 710 can include a base station (BS), a Node B (NB), an evolved Node B (eNB), a baseband unit (BBU), a remote radio head (RRH), a remote radio equipment (RRE), or a remote radio unit (RRU).

The wireless device 720 (e.g., UE) can include a modem module 724 and an application processor 722. The wireless device can be configured performing machine type communication (MTC) services via a non-access stratum (NAS) layer. The modem module can be configured for communication with an evolved Node B (eNB). The modem module can provide NAS layer processing. The application processor can be configured to process an application for an MTC service. The wireless device can include a connection manager 726 (e.g., MTC dispatcher) to identify a MTC type of service in a message and provide an interface between the modem module and the application processor. The connection manager can be included in the modem module or the connection manager.

In another example, the wireless device 720 can include a service capability (SC) layer module 728 configured to generate a request to the application based on an identity of the application in the message and provide an interface between the application and the connection manager. The SC layer module can further include at least one of: a triggering module for processing the request for MTC triggering; a small data module for processing a small data transmission; and a monitoring module for processing an MTC monitoring event request (as illustrated in FIGS. 2-5). In another example, the wireless device can include a NAS controller 730 operating within a protocol stack within the modem module configured to coordinate different RAT signaling via the NAS layer.

In a configuration, the connection manager and the SC layer module can be included in a protocol stack within the modem module. In another configuration, the connection manager can be included in the protocol stack within the modem module and the SC layer module can be outside the protocol stack. In still another configuration, the connection manager and the SC layer module can be outside the protocol stack of the modem module. A module within the protocol stack can be within the modem module. A module outside the protocol stack can be within the application processor. In an example, the connection manager and the SC layer module can be within either the modem module or the application processor.

In an example, the message can be included in a downlink generic NAS transport message with a generic message container type including a MTC device communication indication, or the message can be included in a MTC specific downlink generic NAS transport message for MTC device communication.

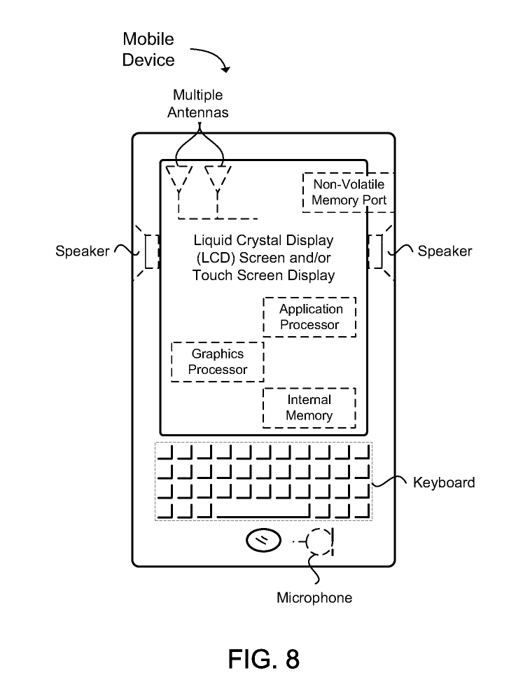

FIG. 8 provides an example illustration of the wireless device, such as an user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard including 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 8 also provides an illustration of a microphone and one or more speakers that can be used for audio input and output from the wireless device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the wireless device. A keyboard may be integrated with the wireless device or wirelessly connected to the wireless device to provide additional user input. A virtual keyboard may also be provided using the touch screen.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. The node and wireless device may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A wireless device configured for providing a machine type communication (MTC) service via a non-access stratum (NAS) layer, comprising:
a NAS layer module to provide mobility management (MM) and session management (SM) for different radio access technology (RAT) signaling via the NAS layer;
an application processor to process an MTC application running on the wireless device; and
an MTC dispatcher operating within the NAS layer module or the application processor to identify an MTC type of service in a message and perform an action based on the MTC type of service.

2. The wireless device of claim 1, wherein the action of MTC dispatcher includes sending a request to the MTC application based on an MTC type of service specified in the message.

3. The wireless device of claim 1, further comprising:
a service capability (SC) layer module including a plurality of MTC service modules,
wherein the MTC dispatcher forwards at least a portion of the message to at least one MTC service module based on the MTC type of service.

4. The wireless device of claim 3, wherein an MTC service module of the SC layer module includes one of a triggering module for processing a request for MTC triggering, a small data module for processing a small data transmission, and a monitoring module for processing an MTC monitoring event request, wherein the MTC service module sends a specified request to the MTC application identified in the message.

5. The wireless device of claim 3, wherein the MTC dispatcher and the SC layer module operate within the NAS layer module.

6. The wireless device of claim 3, wherein the MTC dispatcher operates within the NAS layer module and the SC layer module operates within the application processor.

7. The wireless device of claim 3, wherein the MTC dispatcher and the SC layer module operate within the application processor.

8. The wireless device of claim 1, further comprising:
a NAS controller operating within the NAS layer module to coordinate different RAT signaling via the NAS layer.

9. The wireless device of claim 1, further comprising:
a universal terminal adapter (UTA) in communication with the NAS layer module;
an access stratum (AS) layer module in communication with the NAS layer module to provide radio resource control (RRC) and physical layer processing and signaling;
RAT specific firmware in communication with AS layer module for providing wireless communication using a specified RAT; and
a transceiver module configured to communicate with a node, wherein the node is selected from the group consisting of a base station (BS), a Node B (NB), an evolved Node B (eNB), a baseband unit (BBU), a remote radio head (RRH), a remote radio equipment (RRE), a remote radio unit (RRU), and combinations thereof.

10. The wireless device of claim 1, wherein the different RAT signaling operates based on a wireless technology selected from the group consisting of second generation (2G) digital wireless technology, third generation (3G) digital wireless technology, a third generation partnership project (3GPP) long term evolution (LTE) standard, an Institute of Electrical and Electronics Engineers (IEEE) 802.16 standard, a Worldwide interoperability for Microwave Access (WiMAX) standard, an Universal Mobile Telecommunications System (UMTS) standard, a Global System for Mobile Communications (GSM) standard, a code division multiple access 2000 (CDMA2000) standard, and combinations thereof.

11. The wireless device of claim 1, wherein the message is included in a downlink generic NAS transport message with a generic message container type of an MTC device communication indication.

12. The wireless device of claim 1, wherein the message is included in a MTC specific downlink generic NAS transport message for MTC device communication.

13. The wireless device of claim 1, wherein the wireless device is selected from the group consisting of a user equipment (UE) and a mobile station (MS), and the wireless device includes at least one of an antenna, a touch sensitive display screen, a speaker, a microphone, a graphics processor, an application processor, internal memory, a non-volatile memory port, and combinations thereof.

14. A method for communicating a machine type communication (MTC) service via a non-access stratum (NAS) layer, comprising:
receiving a MTC type of service in a message at a NAS layer module within a wireless device;
forwarding the message to an MTC dispatcher based on a MTC device communication indication within the message; and
performing an MTC service based on an MTC type of service specified in the message.

15. The method of claim 14, wherein performing the MTC service further comprises:
forwarding at least a portion of the message to a service capability (SC) layer module, wherein the SC layer module includes a MTC service module;
sending, from the MTC service module, a request to the application based on an identity of the application in the message; and
performing the MTC service by the application.

16. The method of claim 15, wherein the MTC service module performs the functions selected from the group consisting of:
triggering a request via a triggering module,
processing a small data transmission via a small data module, and
monitoring an event request via a monitoring module.

17. The method of claim 15, further comprising:
operating the MTC dispatcher and the SC layer module within a protocol stack.

18. The method of claim 15, further comprising:
operating the MTC dispatcher within a protocol stack; and
operating the SC layer module outside the protocol stack.

19. The method of claim 15, further comprising:
operating the MTC dispatcher and the SC layer module outside a protocol stack.

20. The method of claim 14, wherein receiving the MTC type of service in the message at the NAS layer module further comprises:
receiving the message at a NAS controller via a specified radio access technology (RAT) signaling; and
sending the message from the NAS controller to the MTC dispatcher.

21. The method of claim 14, wherein the message is included in a downlink generic NAS transport message with a generic message container type including a MTC device communication indication, or the message is included in a MTC specific downlink generic NAS transport message for MTC device communication.

22. At least one non-transitory machine readable storage medium comprising a plurality of instructions adapted to be executed to implement the method of claim 14.

23. A user equipment (UE) for performing machine type communication (MTC) services via a non-access stratum (NAS) layer, comprising:
a modem module for communication with an evolved Node B (eNB), wherein the modem module provides NAS layer processing;
an application processor to process an application for an MTC service; and
a connection manager to identify a MTC type of service in a message and provide an interface between the modem module and the application processor.

24. The UE of claim 23, further comprising:
a service capability (SC) layer module to generate a request to the application based on an identity of the application in the message and provide an interface between the application and the connection manager.

25. The UE of claim 24, wherein the connection manager and the SC layer module are in a protocol stack within the modem module.

26. The UE of claim 24, wherein the connection manager is in a protocol stack within the modem module and the SC layer module is outside the protocol stack.

27. The UE of claim 24, wherein the connection manager and the SC layer module are outside a protocol stack of the modem module.

28. The UE of claim 24, wherein the SC layer module further comprises at least one of:
a triggering module for processing the request for MTC triggering;
a small data module for processing a small data transmission; and
a monitoring module for processing an MTC monitoring event request.

29. The UE of claim 23, wherein the message is included in a downlink generic NAS transport message with a generic message container type including a MTC device communication indication, or the message is included in a MTC specific downlink generic NAS transport message for MTC device communication.

30. The UE of claim 23, further comprising:
a NAS controller operating within a protocol stack within the modem module to coordinate different RAT signaling via the NAS layer.
